(19) United States
(12) Patent Application Publication
(10) Pub. No.: US 2004/0195728 A1
(43) Pub. Date: Oct. 7, 2004

(54) System and method for injection molded micro-replication of micro-fluidic substrates

(76) Inventors: Dennis Slomski, Cupertino, CA (US); Quentin F Polosky, Santa Clara, CA (US); Sanjog Jain, San Jose, CA (US); Heinz Luthi, Lachen (CH); Thomas Fassler, Hombrechtikon (CH)

Correspondence Address: Narinder S Banait, Fenwick & West, Silicon Valley Center, 801 California Street, Mountain View, CA, 94041, US

(21) Appl. No.: 10/493,719

(22) PCT Filed: Oct. 25, 2002
(86) PCT No.: PCT/US02/34172

Related U.S. Application Data
(63) Continuation of application No. 60/348,932, filed on Oct. 26, 2001, now abandoned.

(51) Int. Cl. B29C 45/00

(52) U.S. Cl. 264/328.1

(57) ABSTRACT

A method for forming highly defined and detailed micro-channeled components using injection molding of polymeric material is presented. Such micro-channel components can be created by holding the temperature of the injection cavity and mold in excess of the glass transition temperature of the polymeric material while the polymer is injected. The polymeric material can also be injected under pressure to facilitate the forming of the highly defined micro-features. The newly created polymeric substrate can then be ejected form the mold and used in micro-fluidic and other applications requiring precise and uniform micro-channeled structures.

### TECHNICAL FIELD

The following disclosure relates generally to injection molding and more particularly to injection molding of micro-fluidic substrates.

### BACKGROUND

Micro-fluidics continues to hold a great deal of promise in areas associated with separations, reactions, chemical operations, analysis, and the like. Many of these operations necessitate the use of optical and electromagnetic detection equipment operating on a fluid in small capillaries. These capillaries or micro-channels are typically arranged in a network, wherein, within each network, it is possible to independently perform a step, or series of steps, or a complete analysis by manipulating small volumes of fluid. Operations including mixing, diluting, concentrating and separating reagents can be carried out with extreme precision. A polymeric substrate can have disposed within it multiple such networks forming an array of micro-fluidic structures. These networks across the substrate, however, must possess consistent uniformity and a very high degree of precision. One method of fabricating such substrates is injection molding.

Injection molding of plastic components is a well-known fabrication method. Generally, this process involves the heating of polymer, often in pellet form, until the polymer liquefies and then injecting the molten polymer into a mold cavity. As the polymer is injected into the mold, it freezes retaining the shape of the mold. The newly created device is removed from the mold and the process repeats. These processes work well when large volumes of molten polymer are used and the resultant shape and structural characteristics of the molded part need not meet precision requirements. Micro-structured or micro-fabricated components, however, requires precise and consistent results and the necessity of such precision brings with it complexity and difficulty. United States patents and applications for United States patents reflecting the application of such micro-channel components include U.S. Pat. No. 5,560,811, U.S. Pat. No. 5,858,188, U.S. Pat. No. 5,770,029, U.S. Pat. No. 6,007,690, U.S. Pat. No. 6,074,827, U.S. patent application Ser. No. 09/660,992, and U.S. Patent Application No. 60/201,575.

As used herein, the term “micro-structure”, “micro-scale”, or “micro-fabricated” generally refers to structural elements or feature of a device which have at least one fabricated dimension in the range of from about 0.1 μm to about 500 μm. In general, brief definitions of several terms used herein are preceded by the term being enclosed with double quotation marks. Such definition, although brief, will help those skilled in the relevant art to more fully appreciate aspects of the invention based on the detailed description provided herein. Such definitions are further defined by the description of the invention as a whole (including the claims) and not simply by such definitions. Thus, a device referred to as being micro-fabricated or micro-scaled will include at least one structural element or feature having a dimension in the range of from about 0.1 μm to about 500 μm. When used to describe a fluidic element, such as a passage, assay, chamber, or conduit, the terms micro-scale, micro-fabricated, micro-structure or “micro-fluidic” generally refer to one or more fluid passages, chambers, or conduits which have at least one internal cross-sectional dimension (e.g., depth, width, length, diameter, etc.) that is less than 500 μm, and typically between about 0.1 μm and 200 μm. Typically, micro-fluidic devices include one or more micro-scaled channels that often intersect within a single body. The intersections may include any cross designs such as a “T”, “X” or any number of other structures defined by the intersection of two or more channels.

Generally, the fabrication of micro-structured devices using injection molding requires the polymeric material to be placed in a mold under extreme pressure. The pressure aids the filling of the mold as well as facilitating the formation of the desired structural dimensions. Conventional injection molding typically generates approximately 352 to 1760 bar of pressure during the injection process for molding shots in excess of 3.5 cubic centimeters. However, application of the conventional injection process using molds below 3.5 cubic centimeters can require pressure in excess of 7042 bar to achieve the same results. This is necessary to ensure adequate filling and replication of the various aspects of the mold by the polymeric material. Typically, with injection pressures of this magnitude, the injection time is less than 0.1 seconds. To withstand the pressure, these molds must be constructed of a strong and durable material restricting the formation of intricate micro-structures.

The injection process of micro-structures places other demands on the injection molding process as well. Typically, in conventional injection methods, liquefied polymeric material is introduced into a cold mold cavity under pressure as described herein. The injected polymeric material freezes upon contact with the cold mold. During this process, the material injected in the mold has a tendency to align the individual polymer molecules strands in the molded product in the direction of injection. This alignment or orientation of polymer molecules results in an inherent or frozen stress in the hardened product, as the polymer strands prefer their natural random state. This frozen stress often results in a disproportionate shrinking of the molded part in the length dimension of the aligned polymers, as compared to the width, when the parts are heated to or near their transition temperatures. This shrinking then leads to deformation of the micro-scaled structures and even warping of the part as a whole.

A more significant problem with conventional injection molding of micro-structures is the increasing and detrimental presence of frozen layers. A “frozen layer” is a zone where the fluid transitions from a free flowing liquid to a stationary solid. At the surface of the mold, the, polymeric material is solidified and immobile. Extending away from the mold, the polymeric material transitions to a flowing liquid. A frozen layer is differentiated from a boundary layer, which is the velocity gradient from an immobile surface to a free flowing fluid. In a boundary layer, the material remains in the liquid state although its dynamic velocity varies from zero at the surface to a uniform velocity within the flow. Since the polymeric material freezes upon contact with the cold mold, a growing frozen layer possessing various states of viscosity encircles each of the micro-features of the mold. As the density of the features within the mold increase, the frozen layer surrounding each of these features begins to impede the filling of the mold. The result is a detrimental pressure gradient from the entry gate of the filling material to the exit gate ultimately producing inconsistent and non-uniform results across the mold cavity.

The ejection of the substrate from the injection mold presents yet another problem. To prevent deformation of the part upon opening of the mold, the polymer must be rigid enough to distribute the ejection forces without exceeding the materials yield stress. Even small permanent warping or distortion of the channels, chambers, or conduits can result in degraded fluidic and optical characteristics. Currently, tradeoffs must be accepted between producing a substrate with low frozen stress, the micro-replication of the injection mold features, long cycle times, and commercial viability. While many of the problems of plastic manufacturing have been overcome, the high fidelity micro-replication of arrays of micro-structured substrates continues to plague the microfluidic industry.

### SUMMARY

The micro-replication of highly defined and detailed micro-channel substrates can be accomplished using injection molding where the temperature of the injection cavity and mold is held in excess of the polymeric glass transition temperature for a period of time sufficient to ensure dispersion of the polymer throughout the mold cavity. Micro-channeled devices, including micro-fluidic substrates, often possess networks of intricately designed channels and reservoirs that must be fabricated with extreme precision, uniformity, and consistency. Substrates fabricated from polymeric material can meet these needs using an injection molding method that heats a polymeric material to a liquefied state and injects it into a heated mold core and cavity.

The injection mold cavity, which can be heated by a number of different means, is maintained at a temperature in excess of the glass transition temperature of the polymer for a period of time sufficient to allow the liquid polymer to flow throughout the mold cavity and fill even the most minute features of the injection mold. Once filled, the injection mold's temperature is reduced below the glass transition temperature solidifying the polymer within. With the polymer solidified, the substrate, which now includes the micro-channeled features of the injection mold, can be ejected from the mold.

Micro-fluidic substrates formed using this method possess minimal variations in structural characteristics throughout the substrate. This consistency and uniformity of micro-channel features aids in the performance precision of numerous micro-fluidic applications and analysis techniques. Furthermore, the cycle time of the process is such that it achieves commercial viability. Other aspects of the claimed invention include injecting the liquefied polymer under pressure as well as evacuating the mold cavity prior to injection.

### BRIEF DESCRIPTION OF THE DRAWINGS

FIG. 1 is a flow chart of an embodiment of a method for injection molding of a micro-channeled device.

FIG. 2 is a graph showing temperature versus viscosity of a polymeric material in one embodiment of a method to form polymeric micro-channels substrates using injection molding.

FIG. 3 is a cross sectional view of a mold cavity used in one embodiment of the claimed invention.

FIG. 4 is a graph showing the injection mold heating and cooling cycle time for one embodiment.

FIG. 5 is a cross sectional view of one embodiment of a polymeric micro-fluidic substrate.

FIG. 6 shows one embodiment of a micro-fluidic substrate that includes an array of micro-fluidic networks formed using a method for injection molding of micro-channel devices.

FIG. 7 shows one embodiment of two or more micro-channels and chambers constituting a micro-channel network.

FIGS. 8A-D shows various embodiments of micro-channel cross sections. FIG. 8A shows an embodiment of a “v” cross-sectional micro-channel. FIG. 8B show an embodiment of a trapezoidal cross-sectional micro-channel. FIG. 8C shows a D-shaped cross-sectional micro-channel. FIG. 8D shows a rectangular cross-sectional micro-channel.

FIG. 9 shows an expanded view of the corners forming a rectangular cross-sectional micro-channel.

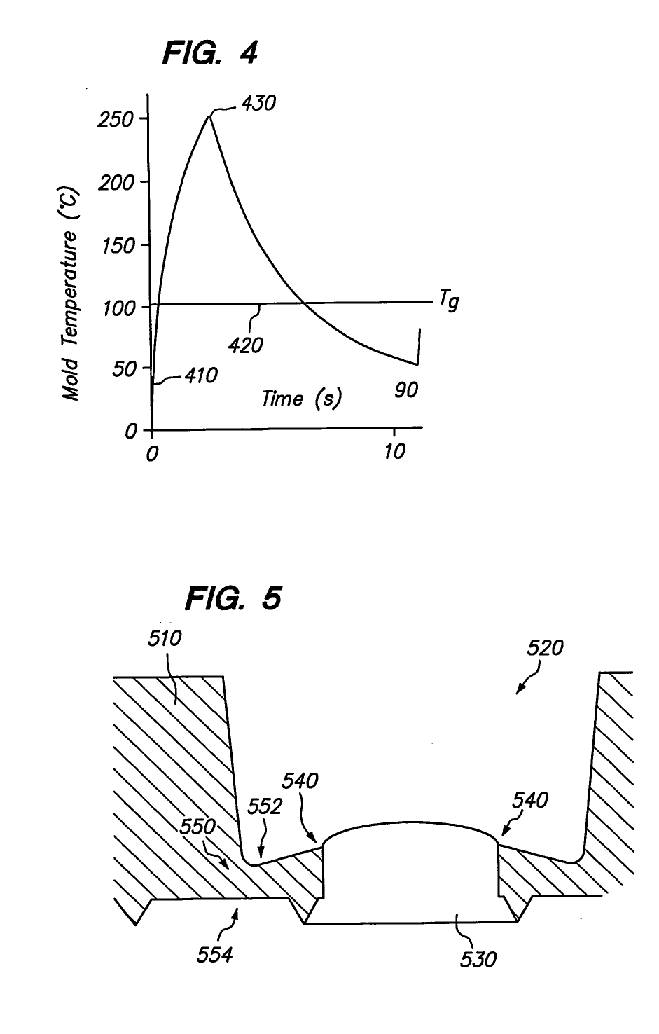

In the drawings, the same reference numbers identify identical or substantially similar elements or acts. To easily identify the discussion of any particular element or act, the most significant digit or digits in a reference number refer to the Figure number in which that element is first introduced (e.g., element 404 is first introduced and discussed with respect to FIG. 4).

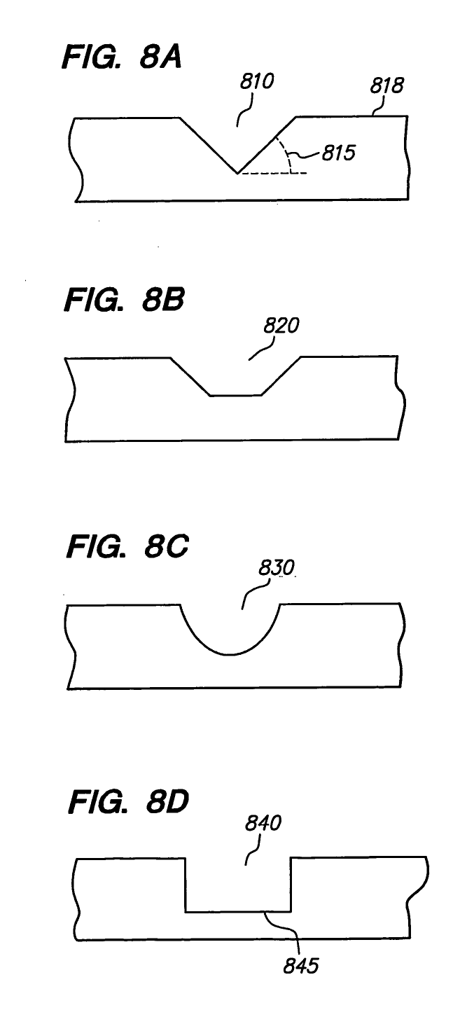

Figure numbers followed by the letters “A,” “B,” “C,” etc. indicate either (1) that two or more Figures together form a complete Figure (e.g., FIGS. 8A and 8B together form a single, complete FIG. 8), but are split between two or more Figures because of paper size restrictions, amount of viewable area within a computer screen window, etc., or (2) that two or more Figures represent alternative embodiments or methods under aspects of the invention.

As is conventional in the field of micro-fluidic representation, the lateral sizes and thickness of the various substrates and networks are not drawn to scale and these various portions are arbitrarily enlarged to improve drawing legibility. Component details have been abstracted in the figures to exclude details such as position of components and certain precise connections between such components when such details are unnecessary to the invention.

### DETAILED DESCRIPTION

The following disclosure describes several embodiments of a system for micro-replicating structures of micro-fluidic substrates using injection molding of a polymeric material. In one embodiment, the micro-replication of micro-structures is accomplished by injection molding of a polymeric material into a heated mold cavity. By heating the mold cavity and core to a temperature above the glass transition temperature of the polymeric material being injected and injecting the material under pressure, micro-replication of micro-fluidic structures can be accomplished. In the following description, numerous specific details, such as specific temperatures, time periods, micro-channel designs, micro-channel network orientations, etc., are provided to convey a thorough understanding of, and enabling description for, embodiments of the invention. One skilled in the relevant art, however, will recognize that the invention can be practiced without one or more of the specific steps, temperature zones, time periods, etc. In other instances, well-known structures or operations are not shown, or are not described in detail, to avoid obscuring aspects of the invention.

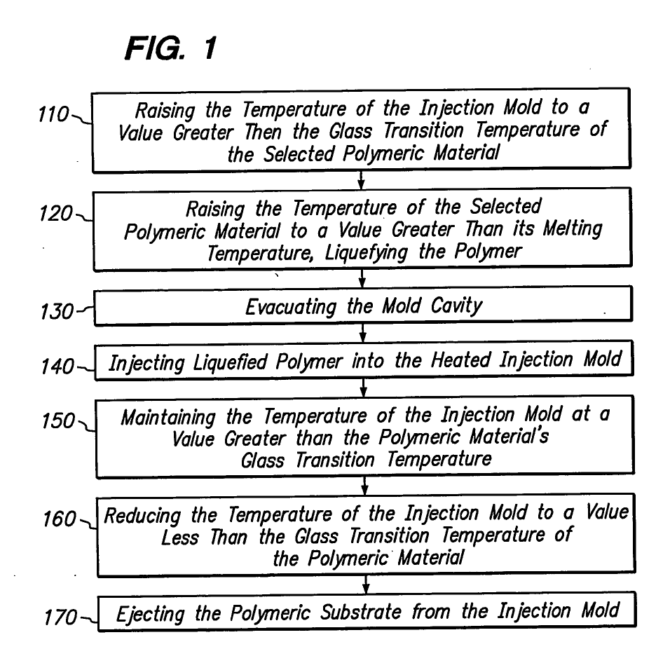

FIG. 1 is a flow diagram of one embodiment for a method for micro-replicating micro-structures consistently and uniformly in a polymeric substrate. Using a polymeric material, the micro-structures found in a micro-fluidic substrate can be formed within the necessary precision and consistency requirements by raising and holding the temperature of the injection mold during the injection process above the glass transition temperature of the polymer. Polymeric material used to fabricate the micro-fluidic devices described herein is typically selected from a wide variety of polymeric material including but not limited to polytetrafluoroethylene, polyethylene, polymethylmethacrylate, polycarbonate, polyvinylchloride, polydimethylsiloxane, polysulfone, polystyrene, polymethylpentene, polypropylene, polyvinylidine fluoride, and acrylonitril-butadiene-styrene copolymer. The criteria used to select the type of material varies according to the application of the micro-channeled substrate and can included considerations such as cost, rigidity, hardness, thermophysical characteristics, optical clarity, fluorescence, refractive indices, dispersion characteristics of coherent and incoherent light, birefringence, water absorption, and the like.

In order to facilitate a complete filling and corresponding cooling of the mold by a polymer, micro-fluidic devices can be formed by injecting a polymeric material into a heated mold cavity. Prior to injection, the mold cavity is raised to a temperature in excess of the glass transition temperature of the polymer to enable the liquefied polymer to flow throughout the mold. Once the cavity is filled, the temperature of the mold is reduced, solidifying the polymeric material. The maximum temperatures of the mold core and mold cavity are controlled so as to prevent the crystalline structure of the polymer being altered. Such alterations may degrade the optical and other physical characteristics of the resulting substrate beyond acceptable limits.

The embodiment shown in FIG. 1 begins by raising the selected polymeric material above its glass transition temperature 110. The glass transition temperature (“T_{g}”), as used herein, defines the temperature where material transitions from a glass-like material to a fluidized, liquid state. Specifically, T_{g} is the temperature at which the polymer chains slip more freely than when in a solid state. The viscosity of a substance is directly related to the slippage, or the movement of molecular strands that make up its composition. Unlike a crystalline material such as water, or semi-crystalline polymers such as polypropylene and polyethylene, an amorphous material exhibits a glassy transition zone where the material changes from a solid to liquid over a wide temperature range. For example, where water undergoes a phase transition at 0° C., an amorphous polymeric substance transforms over a temperature range that is unique to each polymer. In amorphous polymeric substances, as the material reaches its glass transition temperature the viscosity of the material declines. The rate of the decline in viscosity is greater than the rate of the corresponding change of temperature. For example, in a material that has reached its glass transition-point, a 1% increase in the temperature may result in a 2% decrease in the viscosity of the material. The determination of the glass transition temperature for a polymeric material will be recognized by one skilled in the relevant art as being affected by several factors that will not be mentioned here.

The temperature of the mold can be raised in excess of T_{g} decreasing the viscosity of the polymeric material and thus decreasing the frozen layer. As previously mentioned, polymeric material typically produces a characteristic frozen layer surrounding mold features. As the density of the micro-features of the mold increases, the frozen layers can impede the flow of the polymeric material from the entry gate to the end of the mold. Raising the temperature of the mold cavity beyond T_{g} can reduce these restrictions.

As shown by FIG. 1, one embodiment of a method according to the invention for forming a micro-fluidic device comprises the following steps:

Step 110: Raising the temperature of the injection mold to a value greater than the glass transition temperature of the selected polymeric material.

Step 120: Raising the temperature of the selected polymeric material to a value greater than the melting temperature of the selected polymeric material.

Step 130: Evacuating the mold cavity.

Step 140: Injecting the liquefied polymer into the heated injection mold.

Step 150: Maintaining the temperature of the injection mold at a value greater than the polymeric material's glass transition temperature.

Step 160: Reducing the temperature of the injection mold to a value less than the glass transition temperature of the polymeric material.

Step 170: Ejecting the polymeric substrate from the injection mold.

Referring to FIG. 1, one embodiment of the claimed invention begins by heating a polymeric material to reduce viscosity for injection into the injection mold as well as heating the injection mold cavity and core to a temperature greater than the glass transition temperature of the selected polymeric material. The heating of the injection mold core and injection cavity as well as the polymeric material can be accomplished by several means including heated oil circuitry, induction heating, electrical and resistance heating, radiation heating, and any other means by which a consistent and precise control of the temperature environment can be maintained. One embodiment of the claimed invention includes an active and variable heat control of the mold cavity and mold core to achieve a heterogeneous temperature distribution throughout the mold. Such a temperature distribution can optimize the molding environment by alleviating the effect of frozen layers relative to specific mold features (i.e. high density micro-features). The barrel, or the location where the polymeric material is initially liquefied, can be heated and thermally controlled independent of the mold cavity and mold core. Conventional molding typically heats the polymeric material in the barrel and injects the liquefied polymer into a static non-regulated mold. Other conventional techniques heat the mold but do so in a manner that maintains a homogenous temperature distribution.

The injection mold can be constructed with various materials using methods known in the art such that factors such as thermal conductivity, compressive strength, hardness, toughness, coefficient of thermal expansion, porosity, grain size, machinability, homogeneity of the alloy and the like are considered. Induction heating of a thin electroform can also be used to raise the mold cavity and mode core to a temperature above T_{g}. A thin electroform can possess a high degree of thermal conductivity facilitating the reduction of the cooling and heating cycle time. An electroform mold can also incorporate core pins for the forming of wells in the micro-fluidic channels. A detailed description of the integration of core pins in micro-fluidic substrates can be found in Polosky, International Patent Application PCT/US02/21974. As the claimed invention reduces the frozen layer, thus reducing local injection pressure, the deflection and breakage of these pins can be minimized. This can increase the precision of the final product. Furthermore, the heating of the injection mold cavity, core, and of the polymeric material can be accomplished using independent systems or the same heating system. With the temperature of the injection mold, the injection cavity, and the polymeric material greater than the polymer's glass transition temperature, the liquefied polymer is injected into the mold.

As the polymer flows into the mold, the raised temperature of the mold cavity and core surfaces allows the polymer to distribute itself consistently and uniformly throughout the mold with minimal variation of pressure. This consistent pressure profile is due directly to the reduced viscosity of the polymer leading to a smaller frozen layer. The raised temperature impedes contact freezing of the polymeric material that can lead to a restricted polymeric flow to certain regions of the mold and inconsistent formation of the substrate as described herein.

In another embodiment, restricted polymeric flow due to contract freezing can be overcome by increasing the pressure across the mold. High precision substrates containing micro-fluidic networks can be fabricated by injecting a polymeric material into a heated mold under pressure. As the pressure increases, however, the micro-features of the mold can be distorted. Furthermore, as the density of the micro-structured networks increase, the frozen layer can mount causing the pressure gradient to be inconsistent across the injection mold. To alleviate these issues, a lower injection pressure is used in conjunction with a mold cavity heated above the glass transition temperature of the polymer. The lower injection pressure in combination with the raised temperature of the mold cavity can enable the formation of a high density array of microfluidic networks in a single substrate. The uniformity of the polymeric distribution, along with the uniform temperature and pressure distribution throughout the mold, can also minimize inherent molecule orientation due to the tendency for the polymeric molecules to align during the injection process. This uniformity yields a process capable of consistent micro replication of micro-channeled structures.

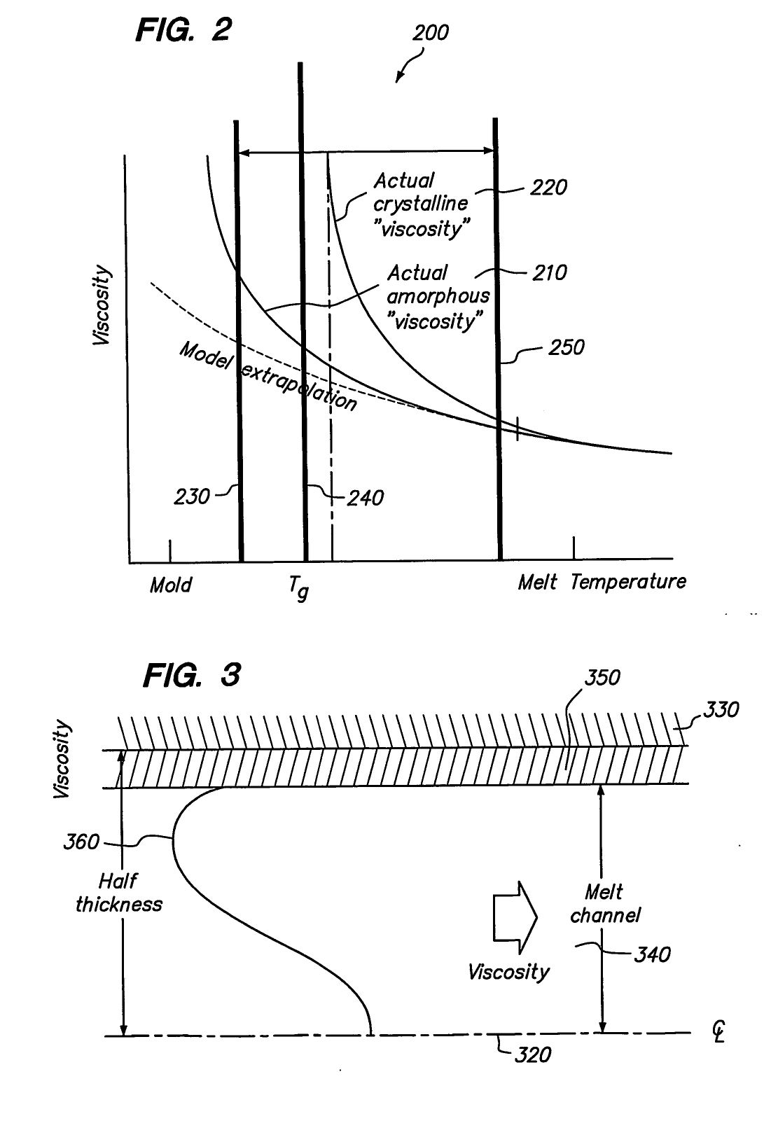

FIG. 2 is a viscosity versus temperature graph for a polymeric material used in one embodiment of a process for forming micro-channeled substrates. The plots on the graph reflect the relationship of viscosity and temperature in both amorphous 210 and semi-crystalline 220 polymers. Superimposed on the graph are lines representing the temperature of a conventional mold 230, the glass transition temperature 240, and a mold with the temperature raised in excess of T_{g} 250. The graph shows that the viscosity of the polymeric material is reduced significantly when heated to a temperature above T_{g}.

The significance of exposing the mold to a polymer possessing a reduced viscosity can be seen in FIG. 3. FIG. 3 is a cross sectional view of a mold cavity used in one embodiment of a method to form micro-channeled polymeric substrates. The vertical axis of the figure represents a cross section of the mold with the bottom of the figure being the is centerline of the mold cavity 320 and the top being the mold wall 330. The horizontal axis represents viscosity of the polymeric material being placed into the cavity 340 with the viscosity increasing from left to right. At the mold wall, the viscosity is a very large number reflecting that the polymeric material is essentially frozen along the wall. This produces a frozen layer 350. The polymer's viscosity within the frozen layer 350 varies moving outward from the mold wall 330 to the centerline of the mold cavity 320. The decrease in viscosity is significant over the small region identified by the frozen layer 350 and reaches a point of inflection as shear rate begins to dominate the relationship between temperature and viscosity. The region of minimum viscosity 360 occurs immediately outside frozen layer due to frictional heating of the polymer. Frictional heating, which is also a reflection of shear rate, is the result of the polymeric molecules near the frozen layer colliding with one another as the material fills the mold. In the center of the mold cavity 320, such melt velocity gradients are minimized. The depth of the frozen layer 350 can be reduced by raising the temperature of the mold wall 330 beyond the polymer's glass transition temperature allowing the polymeric fluid to flow more readily.

Continuing with FIG. 1, while the mold cavity is being filed with the liquefied polymer, the injection mold core and mold cavity are maintained at temperature greater than the glass transition temperature of the polymeric material. Once the polymer melt has volumetrically filled the mold cavity, the temperature of the injection mold cavity and core can be reduced to less than the glass transition temperature of the polymeric material. As the temperature of the polymeric material falls below its glass transition temperature, the polymer solidifies retaining the micro-fluidic structures present in the mold. Typically, the mold will be cooled to a temperature below the glass transition temperate over the range of 30-120 seconds, more preferable over the range of 15-30 seconds, and optimally less than 5 seconds. The cooling temperature, which is less than the glass transition temperature of the polymer, is typically not less than 20° C. below the glass transition temperature and can be within the range of 50-100° C. below the glass transition temperature.

FIG. 4 shows a typical mold cycle time using one embodiment of a process for micro-replication of a micro-channeled substrate with polymeric injection molding. The graph is a temperature versus time depiction of how the mold temperature varies with relation to the glass transition temperature. After the previous substrate has been removed, the temperature of the mold at time zero 410 is increased to above the T_{g} 420 until it reaches its maximum target temperature 430. The heating process typically uses an isothermic heating material, such as oil, maintained at a temperature in excess of the maximum target temperature 430. This results in a decreasing return effect illustrated by the curvature of the temperature profile of the mold. In one embodiment, the mold is filled after the mold temperature reaches or exceeds T_{g} 420. Once filled, an active cooling process is begun and the mold is cooled to a temperature below T_{g} 420 using a different isothermic material. Other methods to cool the mold cavity can be used and will be known to one skilled in the relevant art. With the mold temperature below T_{g} 420, often more than 20° C. below T_{g} 420, the molded part is ejected and the process is repeated.

With the polymeric material solidified within the mold, the mold can be opened allowing the polymeric substrate to be ejected. To prevent any plastic deformation of the substrate, the material is cooled to temperature that provides sufficient rigidity to distribute the ejection forces. The ejection process can be done in a manner to prevent any mechanical introduction of warping or distortion that can adversely affect the functionality of the substrate and micro-channels contained therein. Once the substrate is removed from the injection mold, the injection cavity and injection mold core are reheated to facilitate another injection process. The substrate, with micro-channels intact, can be bonded, using various techniques known to one skilled in the relevant art, to a thin film or other similar materials enclosing the channels and forming a sealed micro-channel network.

FIG. 5 shows one embodiment of a cross sectional view of an assay well 520 formed in a polymeric substrate using the claimed invention. Such assays used in micro-fluidic applications require features possessing precise micro-replication. Further descriptions and examples of micro-structures in micro-fluidic devices can be found in Singh et al, International Patent Publ. WO 00/67907. In one embodiment of the current invention assay wells can be formed so as to be in fluid connection with the micro-channels. Typically, wells are introduced into a substrate and in connection with the channels by using conventional drilling or punching techniques. These conventional techniques can introduce unacceptable deformation of the micro-fluidic structures. The cross sectional view of the assay shows the substrate 510 and the assay well 520. The assay well is configured as a stop junction using the meniscus of a fluid 530 to form the bottom of the well. The performance of the stop junction, which directly affects the performance of the micro-fluidic networks included in a substrate, is determined by the micro-replication of the features 540 bounding the well. There are numerous networks and corresponding wells on a typical micro-fluidic substrate. To form the features 540 with precision and consistency, the polymeric material must flow freely through the mold cavity during injection. Narrow cross-sectional areas 550 can impinge the flow of the polymeric material to the features 540 producing an unfavorable pressure gradient across the mold. Using conventional injection molding, the frozen layer extends from both the top portion of the mold 552 and the bottom portion-of-the mold 554 reducing or blocking the flow of polymeric material into the cavity housing the features 540. The constriction or blockage produces an adverse pressure gradient across the housing. As discussed herein, raising the temperature of the mold above T_{g} reduces the thickness of the frozen layer. With the frozen layer reduced, the narrow areas 550 can experience fewer restrictions allowing the flow of polymeric material to adequately fill the mold and micro-replicate the features 540. This same reasoning and process can be applied throughout the substrate so as to ensure that the critical structures of the micro-fluidic substrate are consistently and precisely formed across a large planar substrate.

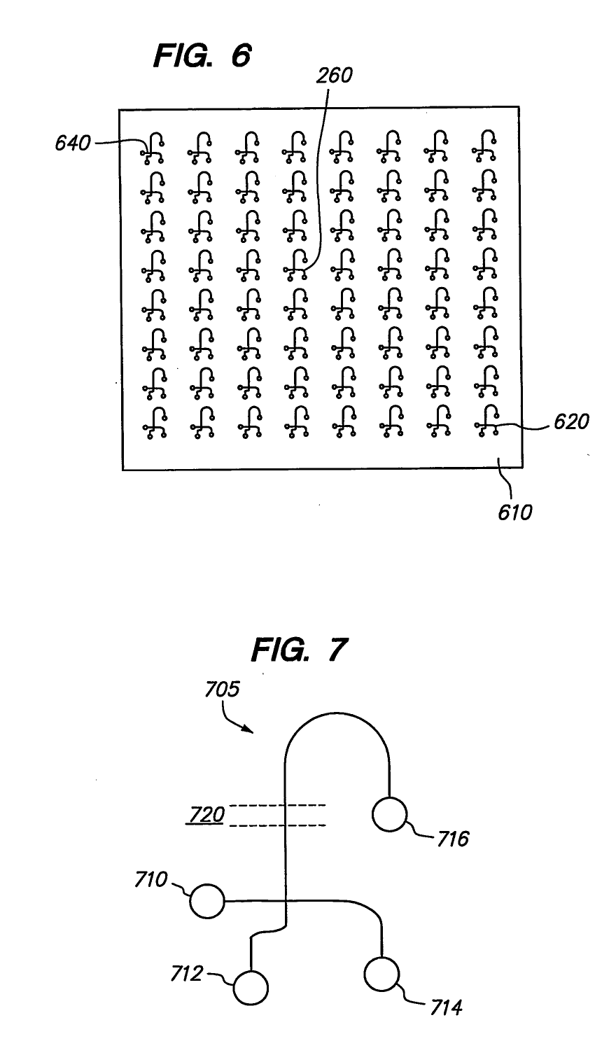

FIG. 6 shows one embodiment of a polymeric substrate formed using injection molding possessing an array of micro-channel networks. The substrate 610 shown possesses 64 micro-channel networks distributed evenly throughout the substrate. Each micro channel network 620, 640, and 660 in the substrate 610 is of the same design. Other embodiments of micro-channel substrates can include more or less micro-channel networks and may include varying micro-network designs. As described herein, the critical nature of operations involving micro-fluidics requires the micro-replication of the networks to be consistent throughout the substrate. The variance in the feature geometry of the micro-channels constituting the micro-channel networks located at the exit gate of the mold cavity of the substrate 640, 620 can be minimized as compared to the structure and geometry of the micro-channel networks located near the injection point, or entry gate, of the substrate 660 by using the injection process described herein. Furthermore, the resulting substrate's planar surface is substantially flat reducing any type of surface distortion or warping.

FIG. 7 shows one embodiment of two or more micro-channels and chambers constituting a micro-channel network. The micro-channels in the substrate can be independent or integrated into a micro-fluidic network 705. Integrated channels and chambers can be designed for specific purposes; i.e. one specific channel is dedicated to injecting a sample while another can be designed for analysis or separation. Channels generally have a depth of about 10 to 200 μm and a width in the range of about 1 to 500 μm. A detection zone 720 is generally incorporated into the channels that are designed for purpose of separation or other analysis. The location of these detection zones 720 along the length of the analysis channel depends upon the application for which the network is being used. Supply and waste reservoirs, or assays, 710, 712, 714, and 716 can be disposed in the substrate and in fluid connection with the micro-channels within the network 705.

FIGS. 8A-8D show cross-sectional views of embodiments of micro-channels that can be included in the micro-channeled networks described herein. FIG. 8A shows a “V” shaped micro-channel 810 with the walls of the channel typically forming a 45° angle 815 with the planar surface of the substrate 818. The angle formed by the walls of the micro-channel can be generally in the range of 30-60°, preferably in the range of 40-55° and optimally 45°. FIG. 8B shows a micro-channel with a trapezoidal cross section 820. The walls of the trapezoidal micro-channel 820 are generally orientated similarly to the “V” shaped micro-channel 810 described herein. FIG. 8C shows a D-shaped cross-sectional micro-channel 830 and FIG. 8D shows a rectangular micro-channel 840. The rectangular cross section generally possesses walls that are substantially perpendicular to the planar surface of the substrate 818 with a floor 845 parallel to the planar surface. Other geometric shapes can be used in forming a micro-fluidic device depending on the operation requirements. Variations between these geometric shapes are dependent upon parameters involved with the relation between the media that is held by the channel and the composition of the substrate itself.

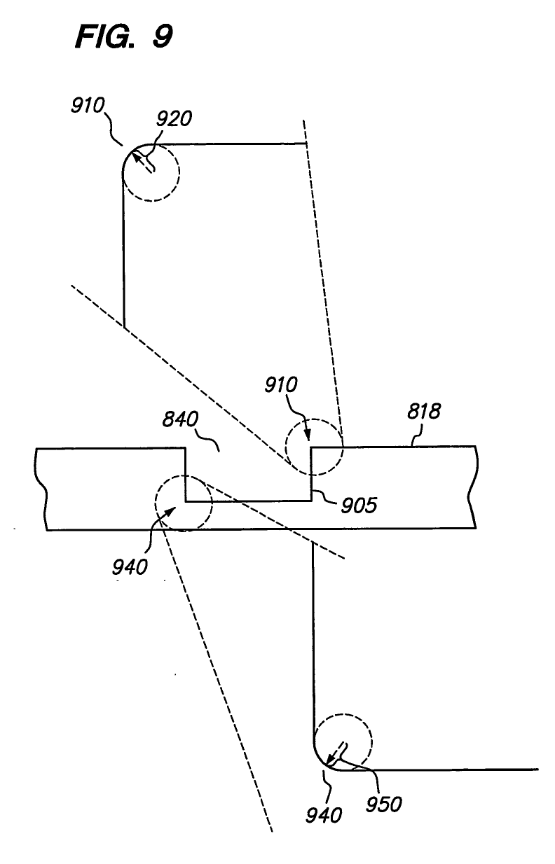

FIG. 9 shows two expanded views of a rectangular cross section 940 of a micro-channel. The exterior corner 910 created by the intersection of the planar surface of the substrate 818 and the vertical wall of the micro-channel 905 is expanded. The exterior corner 910 possesses a radius of curvature 920 that is a function of the injection molding process. Likewise, the interior corner 940 of the rectangular cross section 840 is expanded showing a radius of curvature 950. The sharpness of the interior corners 940 and the exterior corners 910 are determined directly by the effectiveness of the injection molding process described herein and are typical of the micro-replication achieved through the claimed method. Characteristics of the fluid flow through the micro-fluidic channels are a function of the shape and texture of the micro-fluidic channels. Using the methods described herein, micro-fluidic channels can be micro-replicated throughout the substrate with interior and exterior corners having radii of curvature in the range of 3 to 33 μm.

The coefficient of variation of the micro-channeled networks can be minimized by the fabrication methods described herein. The coefficient of variation is defined as the standard deviation divided by the mean. For example, if a survey of the exterior radii of curvature produced a mean of 24 μm with a standard deviation of 2 μm the coefficient of variation would be 0.0833 or 8.3%. Using the methods described herein, coefficients of variation for micro-structures contained within a polymeric injection molded substrate can generally be less than 1.0 and normally in the range of 0.01 to 0.5, preferably in the range of 0.001 to 0.01 and optimally less than 0.001.

For example, using the polymeric material, polyolefin norbornene, a micro-fluidic substrate can be formed using the injection molding methods describe herein that will meet necessary operational tolerances. By raising the injection mold to a temperature in excess of the glass transition temperature and injecting the liquefied polymer into the mold under pressure, a micro-fluidic substrate can be achieved that has a coefficient of variation less than 1.0.

Referring once again to FIG. 1, an additional step of evacuating the mold cavity of any atmosphere can be accomplished in conjunction with the heating of the injection mold cavity to facilitate the forming of the substrate. In general, alternatives and alternative embodiments described herein are substantially similar to previously described embodiments, and common elements and acts or steps are identified by the same reference numbers. Only significant differences in construction or operation are described in detail. By removing the atmosphere within the injection mold cavity, the polymer need not displace another fluid when it is placed into the mold. Air is a fluid much like the liquefied polymer but possessing different characteristics. While the physical characteristics of an atmosphere gas and a liquefied polymer are substantially different, both cannot occupy the same space. To create a consistent and uniform polymeric substrate, the liquefied polymer must completely occupy the mold cavity. If the cavity is occupied by an atmosphere prior to the injection, this atmosphere must be displaced or compressed into the polymer to achieve the desired consistent and uniform results. By evacuating the mold cavity to a vacuum or near vacuum, the liquefied polymer can flow freely into the mold and eliminate any trapped atmosphere that would destroy the uniformity of the substrate.

Similarly, delivering the liquefied polymer under high pressure is another aspect of the claimed invention. Delivering the liquefied polymer into the mold can assist the polymer in displacing any residual atmosphere that may be present in the mold cavity. Additionally, as described herein the inherent high viscosity of liquefied polymers can impede their ability to-occupy minute features often found in the molds defining the micro-fluidic devices. By injecting the polymer under high pressure, areas which would be ill formed under ambient pressure can achieve the level of detail and consistency generally accepted for use in micro-fluidics.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, when used in this application, shall refer to this application as a whole and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other injection molding methods, not only for the injection molding of micro-channeled components described herein.

The elements and aspects of the various embodiments described herein can be combined to provide further embodiments beyond those already described. All of the above references and U.S. patents and applications are incorporated herein by reference. Aspects of the claimed invention can be modified, if necessary, to employ the systems, functions and concepts of the various patents and applications described herein to provide yet further embodiments of the claimed invention.

These and other changes can be made to the invention in light of the above detailed description. In general, in the following claims, the terms used should not be construed to limit the invention to the specific embodiments described above in the specification and the claims, but should be construed to include all injection molding systems that operate under the claims to provide a method for producing a micro-fluidic polymeric substrate. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in an injection process, other aspects may likewise be embodied in micro-channeled device. Accordingly, the inventors reserve the right to add additional claims after filing the application to pursue such additional claim forms for other aspects of the invention.

We claim:

1. A method for forming a micro-fluidic device, comprising:
raising the temperature of an injection mold T1 to a temperature greater than the glass transition temperature of a polymer T2, wherein the injection mold defines a polymeric substrate having a planar surface with a side dimension of at least 2 inches, the planar surface including two or more micro-channel networks defining an array of micro-channel networks, each network including two or more micro-channels, distributed over the planar surface;
increasing the temperature of the polymer greater than T2 creating a liquefied polymer;
injecting the liquefied polymer into the injection mold under pressure P;
maintaining the temperature of the injection mold greater than T2 allowing the liquefied polymer to disperse throughout the mold;
reducing the temperature of the injection mold to a temperature less than T2 solidifying the liquefied polymer; and
ejecting the polymeric substrate from the injection mold, wherein the planar surface of the polymeric substrate is substantially flat.

2. A micro-fluidic substrate formed in accordance with the method of claim 1.

3. In a method of forming a micro-fluidic device composed of a polymeric substrate having a movement area with side dimensions of at least about 2 inches and two or more micro-channel networks defining an array of micro-channel networks, each network including two or more micro-channels, formed in the polymeric substrate and distributed over the expanse, by injecting a fluidized polymer into an injection mold, an improvement comprising:
raising the temperature of the mold to greater than the glass-transition temperature of the polymer, with the temperature of the mold maintained above the polymer's glass transition temperature;
injecting the fluidized polymer into the injection mold
maintaining the temperature of the injection mold greater than the glass transition temperature of the polymer allowing the polymer to distribute throughout the mold;
cooling the mold below the polymer's glass transition temperature producing a substrate having a substantially flat movement area.

4. A micro-fluidic substrate, comprising a polymeric substrate formed in an injection mold with the temperature of the injection mold raised above the glass transition temperature of a polymer prior to injection, and subsequently cooled to a temperature less than the glass transition temperature after injection of the polymer, wherein the polymeric substrate has a planar surface with a side dimension of at least 2 inches and has two or more micro-channel networks defining an array of micro-channel networks, each network including two or more micro-channels being in fluid connectivity with each other, the array distributed over the planar surface.
